(19) United States
(12) Patent Application Publication
(10) Pub. No.: US 2011/0039045 A1
(43) Pub. Date: Feb. 17, 2011

(54) CORRUGATED CONTAINER HAVING LINER LAYERS OF DIFFERENT DIMENSION

(75) Inventor: William Scott Russell, Schenectady, NY (US)

Correspondence Address: HOFFMAN WARNICK LLC, 75 STATE STREET, 14TH FLOOR, ALBANY, NY, 12207, US

(73) Assignee: NORAMPAC SCHENECTADY, INC., Schenectady, NY (US)

(21) Appl. No.: 12/539,206

(22) Filed: Aug. 11, 2009

(51) Int. Cl. B32B 1/02; B32B 3/28; B32B 29/08; B32B 37/00

(52) U.S. Cl. 428/34.2; 428/182; 428/152; 156/543; 156/292; 428/155

(57) ABSTRACT

A corrugated fiberboard container and a method and apparatus for constructing corrugated fiberboard in which different liner materials are utilized for forming the container body and flaps. A corrugated fiberboard is disclosed for use in providing a container. The fiberboard includes: a first region that forms a container body; and a second region that forms a plurality of flaps; wherein the first region and the second region are formed from a fluted medium having a liner adhered to a side of the fluted medium, wherein the liner includes: a first layer that substantially covers both the first region and the second region; and a second layer adhered to the first layer, wherein the second layer covers the first region and is omitted from covering at least a substantial portion of the second region.

### FIELD OF THE INVENTION

This disclosure is related to a corrugated container and its construction, and more particularly to a corrugated container having liner layers of different dimension such that different materials are utilized for forming different regions of the container.

### BACKGROUND OF THE INVENTION

Corrugated fiberboard, also known as corrugated cardboard, is a paper-based construction material consisting of a fluted corrugated sheet and one or two flat linerboards (“liner”). It is widely used in the manufacture of corrugated boxes, bins and shipping containers.

FIG. 1 depicts an example of a sheet of corrugated fiberboard 10 having a first liner 12, a second liner 14 and a fluted medium 16. The corrugated medium 16 and liners 12 and 14 are made of paperboard, a paper-like material usually over nine mils thick. (Paperboard and corrugated fiberboard are sometimes referred to as cardboard, although cardboard might be any heavy paper-pulp based board.)

FIG. 2 depicts a box blank 18 for a regular slotted container cut from a sheet of corrugated fiberboard. As can be seen, box blank 18 includes cut-outs 20 and creases 22 to form a box body 24 and flaps 26. FIG. 3 depicts a resulting corrugated fiberboard box 28 formed from the box blank 18 of FIG. 2.

One of the challenges with constructing corrugated fiberboard is to find ways to reduce the amount of paperboard or fiber required to produce a box in order to save cost and conserve resources.

### SUMMARY OF THE INVENTION

The present invention relates to a corrugated fiberboard container and a method and apparatus for constructing corrugated fiberboard in which different sized liner layers are utilized for forming different regions of the container, such as the body and flaps. In one embodiment, there is a corrugated fiberboard for use in providing a container, comprising: a first region that forms a container body; and a second region that forms a plurality of flaps; wherein the first region and the second region are formed from a fluted medium having a liner adhered to a side of the fluted medium, wherein the liner includes: a first layer that substantially covers both the first region and the second region; and a second layer adhered to the first layer, wherein the second layer covers the first region and is omitted from covering at least a substantial portion of the second region.

In a second embodiment, there is a container, comprising: a body; and a plurality of flaps; wherein the body and plurality of flaps are formed from a fluted medium and a liner, wherein the liner includes: a first layer that substantially covers both the body and the plurality of flaps; and a second layer that covers the body and is omitted from covering at least a substantial portion of each of the plurality flaps.

In a third embodiment, there is an apparatus for constructing a corrugated fiberboard, comprising: a mechanism for holding a first roll of linerboard having a first width; a mechanism for holding a second roll of linerboard having a second width less than the first width; a system for forming a liner having two layers, wherein a first layer is obtained from the first roll of linerboard and a second layer is obtained from the second roll of linerboard, and wherein the first layer and second layer are adhered together; a mechanism for holding a roll of corrugated medium having a width substantially equal to the first roll of linerboard; and a system for adhering the liner to the corrugated medium to provide a corrugated fiberboard.

In a fourth embodiment, there is a method for forming a corrugated fiberboard, comprising: providing a first roll of linerboard having a first width; providing a second roll of linerboard having a second width less than the first width; forming a liner having two layers, wherein a first layer is obtained from the first roll of linerboard and a second layer is obtained from the second roll of linerboard, and wherein the first layer and second layer are adhered together; providing a roll of corrugated medium having a width substantially equal to the first roll of linerboard; and adhering the liner to the corrugated medium to provide a corrugated fiberboard.

In a fifth embodiment, there is a corrugated fiberboard, comprising: a first region of corrugated fiberboard for providing a first portion of the container that requires a first amount of structural integrity; and a second region of corrugated fiberboard for providing a second portion of the container that requires a second amount of structural integrity, wherein the second amount of structural integrity is less than the first amount; wherein both the first region and second region are formed from a fluted medium having a liner adhered to a side of the fluted medium, wherein the liner includes: a first layer that substantially covers both the first region and the second region; and a second layer adhered to the first layer, wherein the second layer covers the first region and is omitted from covering at least a substantial portion of the second region.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a corrugated fiberboard.

FIG. 2 depicts a box blank.

FIG. 3 depicts a box formed from the box blank of FIG. 2.

FIG. 4 depicts a liner for a corrugated fiberboard in accordance with an embodiment of the present invention.

FIG. 5 depicts an end view of the liner of FIG. 4 along A-A in accordance with an embodiment of the present invention.

FIG. 6 depicts an isometric view of a liner in accordance with an embodiment of the present invention.

FIG. 7 depicts a method for forming a liner in accordance with an embodiment of the present invention.

FIG. 8 depicts an apparatus for forming corrugated fiberboard using an in-line process for providing a multilayer linerboard and resulting box blanks in accordance with an embodiment of the present invention.

FIG. 9 depicts a box blank in accordance with an embodiment of the present invention.

FIG. 10 depicts a resulting box from the box blank of FIG. 9 in accordance with an embodiment of the present invention.

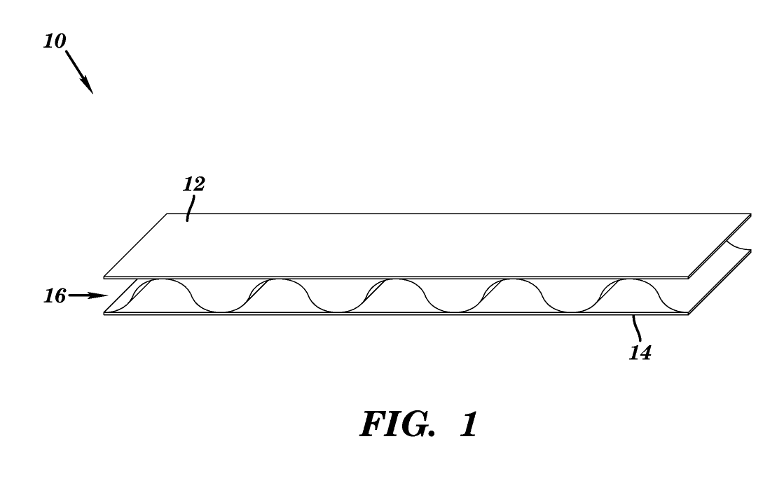

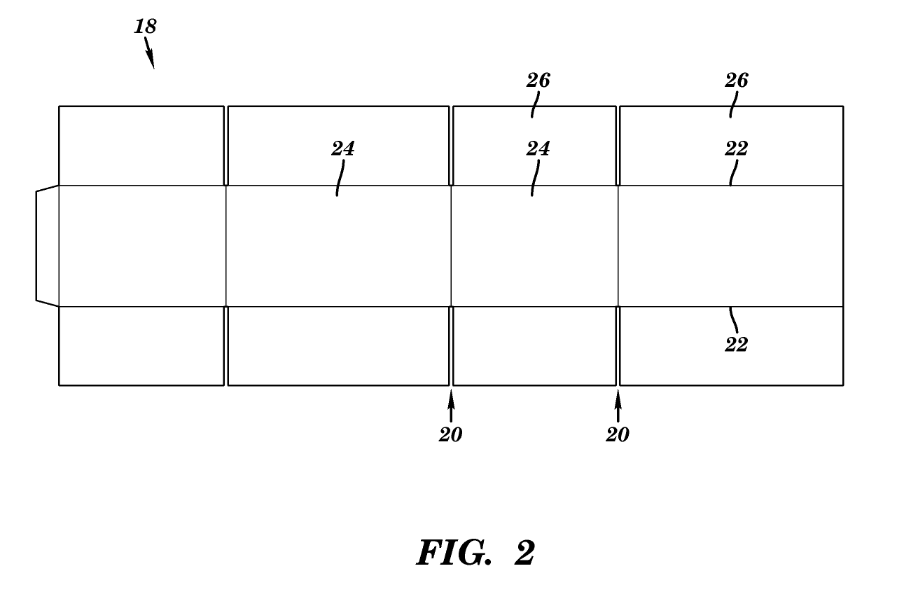

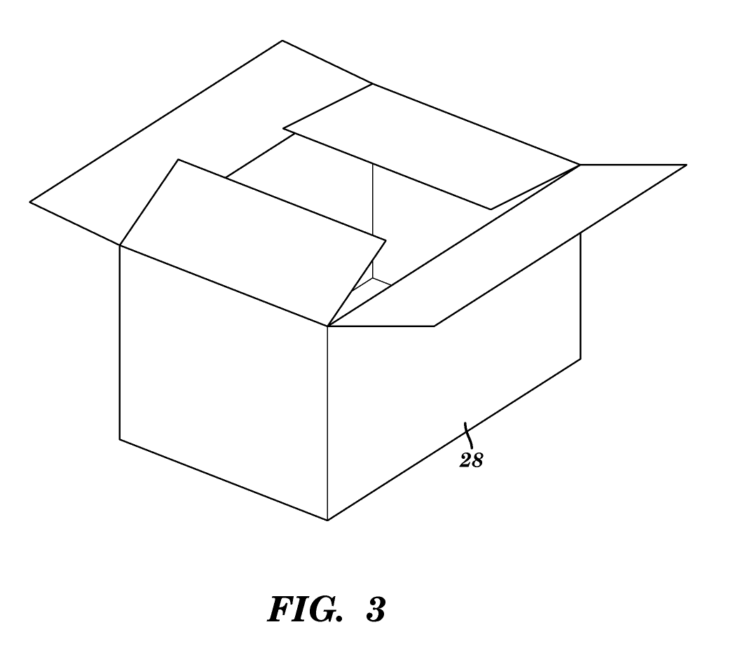

The drawings are merely schematic representations, not necessarily drawn to scale and not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The present invention provides an improved corrugated container that utilizes less paper and thus saves natural resources and costs. For the purposes of this disclosure, the term “corrugated fiberboard” refers to any paper based board that includes at least one fluted corrugated sheet (a medium) and at least one liner. In addition, the term “container” refers to any container, box, bin, etc., constructed from corrugated fiberboard.

An improved corrugated container is achieved by implementing a multilayer liner on at least one side of the medium, in which a layer is selectively omitted from regions of the fiberboard where structural integrity is not as important, such as on the flaps. In one embodiment, the layer does not extend the full width of the corrugated fiberboard. While two layer liners have been used to form liners in the past to increase strength with reduced paper, selectively omitting a layer from regions of the fiberboard where structural integrity is lower provides significant savings.

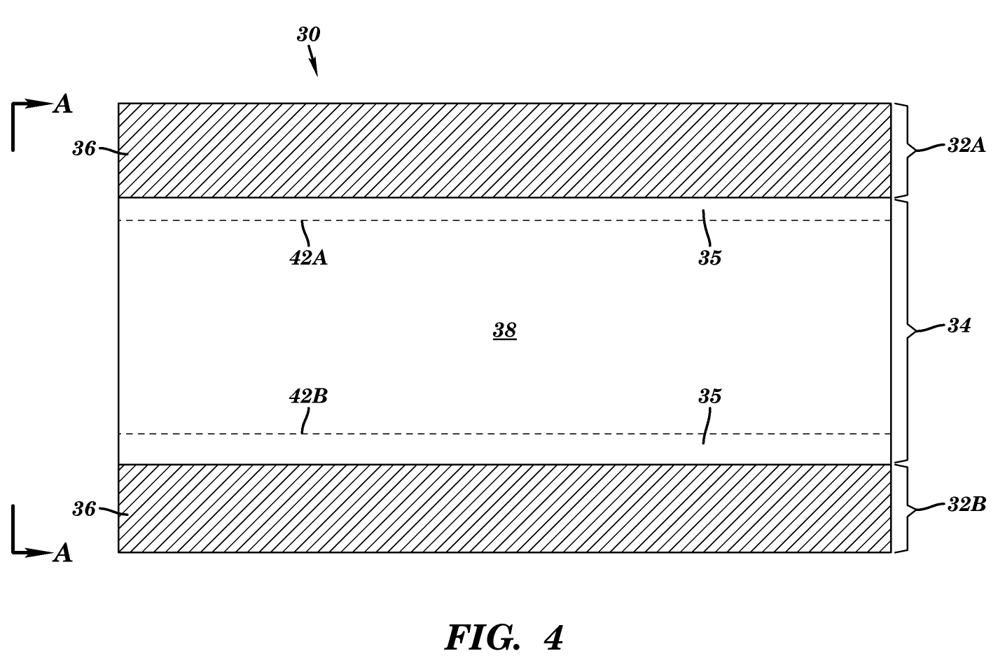

FIG. 4 depicts an illustrative embodiment of a two layer liner 30 having a first layer 36 that fully covers the corrugated medium (not shown) and a second layer 38 that does not cover the full width of the medium, but instead only covers a portion of the first layer 36. In this embodiment, the second layer 38 is essentially a band that covers a central portion of the first layer 36. However, it is understood that any variations with respect to the location, dimensions and positioning of the second layer 38 are included within the scope of the invention. For example, second layer 38 could be offset from the central portion, aligned along an edge, limited to a narrow band positioned near a score (i.e., fold line) or on a flap but not aligned to the edge, etc.

In this example, liner 30 is divided into three regions: body region 34 that will ultimately reside on the body of a container; and flap regions 32A and 32B that will ultimately reside on the flaps of the container. Crease (or fold) lines 42A and 42B show where the flap regions 32A and 32B meet the body region 34. As can be seen, first layer 36 covers both the body region 34 and the flap regions 32A and 32B. Second layer 38 however only fully covers the body region 34 and covers overlaps 35 of the flap regions 32A, 32B.

Thus, because the body region 34 of the liner 30 receives two layers 36, 38 of the liner 30, it meets more demanding structural integrity requirements. Conversely, the flap regions 32A, 32B receive primarily only the first layer 36 of the liner 30 since the structure integrity requirements are substantially lower.

Overlaps 35 are optionally provided to avoid potential failure along creases 42A and 42B and to allow for misalignment. The amount of overlap 35 can vary, e.g., an inch or so, but is generally configured to leave a substantial portion of flap regions 32A and 32B with only a single layer. It is understood that overlaps 35 are not necessary. In other words, the second layer 38 could simply extend to or proximate the crease lines 42A, 42B. Regardless, the resulting structure provides: (1) a first layer 36 that substantially covers both a body region and flap regions of a resulting container, and (2) a second layer adhered to the first layer, wherein the second layer covers the body region and is omitted from covering at least a substantial portion of the flap regions.

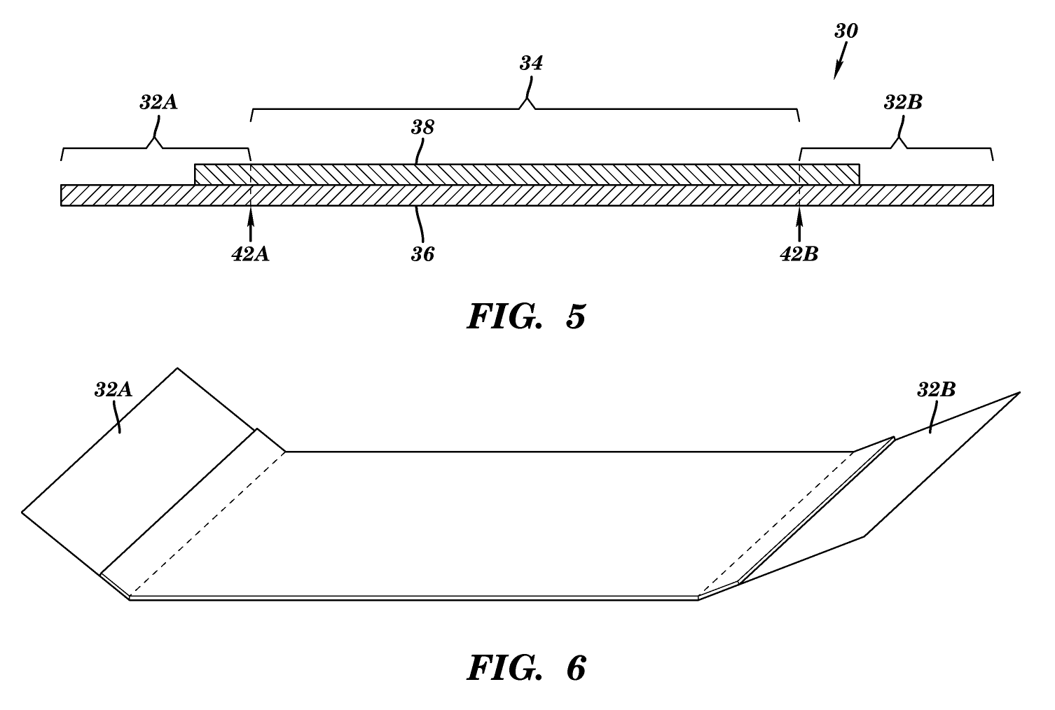

FIG. 5 depicts an end view of the liner 30 along perspective A-A of FIG. 4. In this figure, the thicknesses of the two layers 36 and 38 have been exaggerated. In an illustrative embodiment, first layer 36 may comprise, e.g., a 31 pound linerboard and the second layer may comprise a 23 pound linerboard. Accordingly, the body region 34 would have the equivalent of 54 pounds of linerboard (with a combined strength, once laminated, approximately equivalent to that of a 90 pound linerboard), while the flap regions 32A and 32B would have just the 23 pounds of linerboard. Obviously, the thicknesses and characteristics of the layers 36 and 38 are not limited to a particular type, value or range of values. Furthermore, it is understood that the liner 30 could include more than two layers in which at least two of the layers had different sizes.

FIG. 6 depicts an isometric view of the liner with flaps 32A and 32B folder along the crease lines. Note that FIGS. 4-6 are shown without the corrugated medium in order to assist in describing the liner configuration. In one embodiment, the second, i.e., smaller, layer 38 (FIG. 5) is sandwiched between the corrugated medium and the first layer 36 to avoid tearing. However, it is understood that the corrugated medium could be positioned on either side of the liner. In addition, it is understood that a two layer liner 30 could be adhered to one or both sides of the corrugated medium.

It is also understood that while the above embodiments describe a fiberboard application involving the use of different liner layers for the flaps and body, the invention is not limited to these specific embodiments. Rather, the invention applies to any fiberboard application in which different regions require different structural integrity.

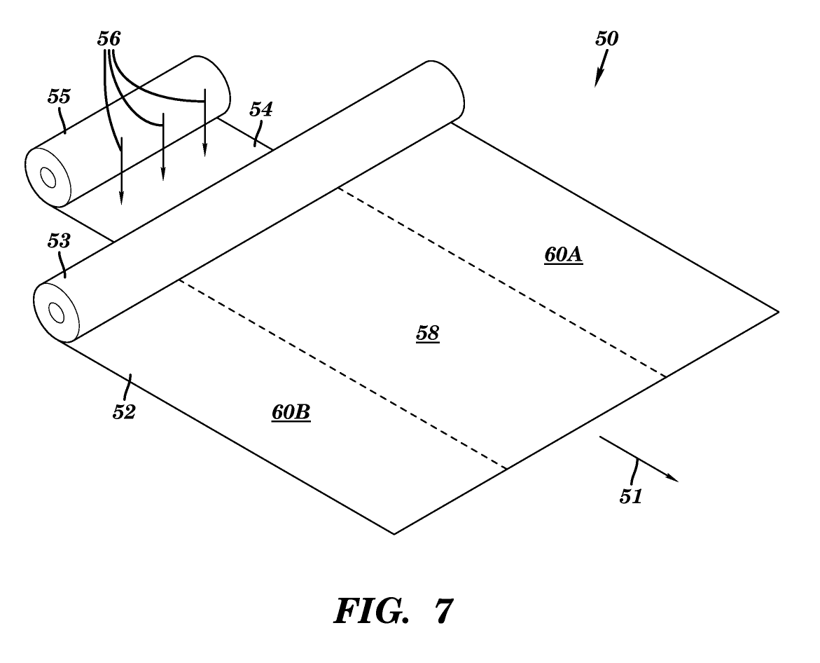

FIG. 7 depicts an illustrative method for forming a two layer liner 50. In this embodiment, two rolls 53, 55 of liner board layers 52 and 54 are positioned to unroll in unison toward arrow 51. An adhesive 56 is applied to a top surface of layer 54 such that it will adhere to a bottom surface of layer 52, or it can be applied to the bottom of liner 52 so it adheres to the top of liner 54. The result is a liner 50 that includes a central portion 58 having two layers, and two edge portions 60A and 60B having a single layer. Note that any type of adhesive (e.g., PVA or cornstarch based) may be utilized. Also note that while all of the embodiments described generally include a liner 50 with a central portion 58 having two layers and two edge portions 60A, 60B having a single layer, it is understood that other configurations are possible. For instance, an edge of roll 55 could line up with an edge of roll 53 such that, e.g., portion 60B includes two layers and only 60A includes one layer. Alternatively, roll 55 could be split and separated such that portions 60A, 60B receive two layers and portion 58 only received one layer. Further, a third roll of liner board could be incorporated to create more a complex liner having three or more layers, with potentially different thicknesses.

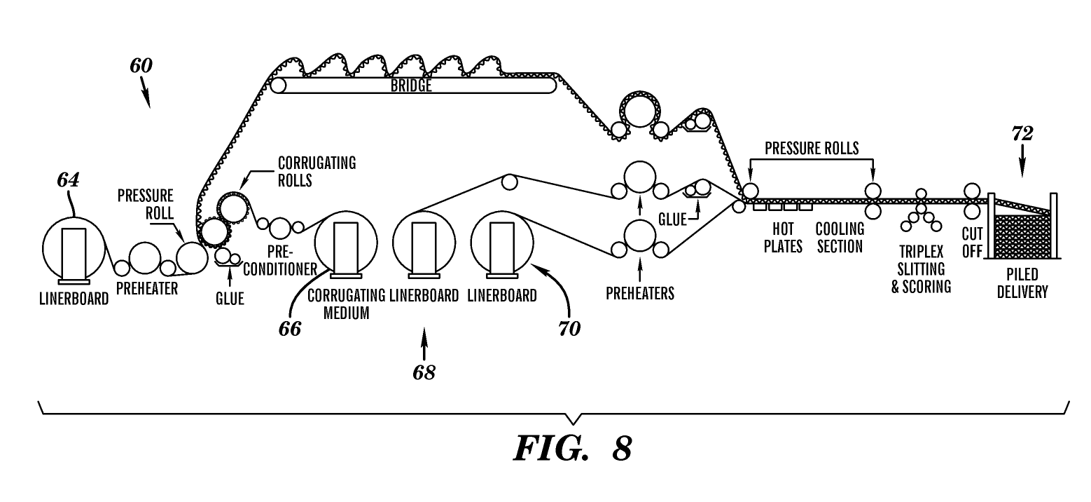

FIG. 8 depicts a simplified schematic of a corrugator apparatus 60 for incorporating an “in-line” two layer liner onto one side of the corrugated fiberboard (i.e., box blanks) 72. Corrugator apparatus 60 includes a corrugated medium source 66 (e.g., a mechanism holding a roll of corrugating medium) and a first linerboard source 64 (e.g., a mechanism holding a roll of linerboard). The linerboard from the first linerboard source 64 is applied to a first side of the corrugated paper in a normal manner. The opposite side of the corrugated linerboard however receives a two layer linerboard, which is implemented in an in-line fashion.

The two layer linerboard is formed with two linerboard sources 68 and 70 that run parallel to each other, such that the two linerboards are unrolled in unison, mated and glued in an in-line fashion, as the corrugated fiberboard 72 is being manufactured. It is understood that a second similar modification could be made at first linerboard source 64 to obtain a two layer liner on both sides of the corrugated fiberboard. It is also possible to form a linerboard having more than two layers using a similar approach. Note that this in-line process allows the manufacturer to control the selection of the layer dimensions at the time of manufacture. In an alternative embodiment, one of the linerboard sources could be “pre-manufactured” with two or more layers of different dimension, e.g., as shown in FIG. 7. Note that the apparatus shown in FIG. 8 is depicted for illustrative purposes only, and variations are possible.

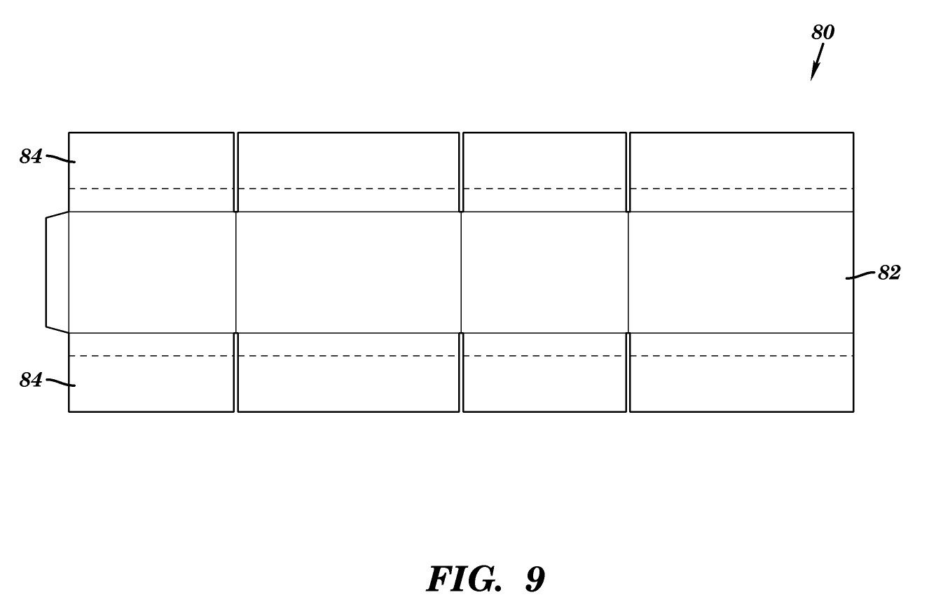

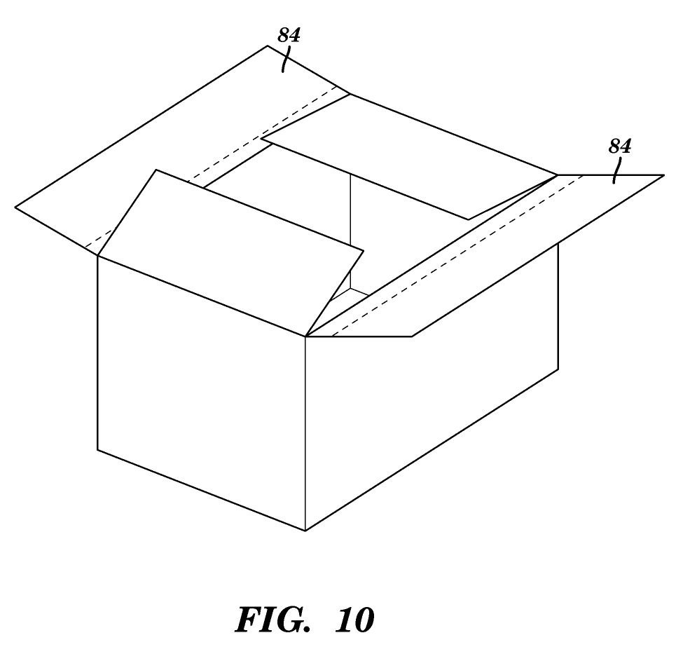

FIG. 9 depicts a resulting box blank 80 that includes a first portion 82 between the dash lines that has a two layer liner, and a second portion 84 outside the dashed lines that has only a single layer liner. FIG. 10 depicts the resulting box and indicates that the interior liner region 84 on the flaps has only a single layer liner.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A corrugated fiberboard for use in providing a container, comprising:
a first region that forms a container body; and
a second region that forms a plurality of flaps;
wherein the first region and the second region are formed from a fluted medium having a liner adhered to a side of the fluted medium, wherein the liner includes:
a first layer that substantially covers both the first region and the second region; and
a second layer adhered to the first layer, wherein the second layer covers the first region and is omitted from covering at least a substantial portion of the second region.

2. The corrugated fiberboard of claim 1, further including a crease line that separates the first region from the second region.

3. The corrugated fiberboard of claim 2, wherein the second layer extends over the crease line.

4. The corrugated fiberboard of claim 1, wherein the first layer includes a linerboard having a first weight and the second layer includes a linerboard having a second weight that is different from the first weight.

5. The corrugated fiberboard of claim 4, wherein the first weight is approximately 31 pounds and the second weight is approximately 23 pounds.

6. The corrugated fiberboard of claim 1, wherein the second region includes cutouts.

7. A container, comprising:
a body; and
a plurality of flaps;
wherein the body and plurality of flaps are formed from a fluted medium and a liner, wherein the liner includes:
a first layer that substantially covers both the body and the plurality of flaps; and
a second layer that covers the body and is omitted from at least a substantial portion of each of the plurality flaps.

8. The container of claim 7, further comprising crease lines that separate the body from the plurality of flaps, wherein the second layer extends onto a portion each flap.

9. The container of claim 7, further comprising crease lines that separate the body from the plurality of flaps, wherein the second layer ends extends to the fold lines.

10. The container of claim 7, wherein the first layer includes a linerboard having a first weight and the second layer includes a linerboard having a second weight that is different from the first weight.

11. The container of claim 10, wherein the first weight is approximately 31 pounds and the second weight is approximately 23 pounds.

12. The container of claim 7, wherein the first layer is adhered to the second layer.

13. An apparatus for constructing a corrugated fiberboard, comprising:
a mechanism for holding a first roll of linerboard having a first width;
a mechanism for holding a second roll of linerboard having a second width less than the first width;
a system for forming a liner having two layers, wherein a first layer is obtained from the first roll of linerboard and a second layer is obtained from the second roll of linerboard, and wherein the first layer and second layer are adhered together;
a mechanism for holding a roll of corrugated medium having a width substantially equal to the first roll of linerboard; and
a system for adhering the liner to the corrugated medium to provide a corrugated fiberboard.

14. The apparatus of claim 13, wherein the second layer is positioned in a substantially central portion of the first layer such that the liner includes a central region having two layers and two edge regions having a single layer.

15. The apparatus of claim 13, wherein the second layer is positioned substantially along an edge portion of the first layer such that the liner includes a first region having two layers and a second region having a single layer.

16. The apparatus of claim 13, wherein the second layer comprises a band positioned near a score or on a flap.

17. A method for forming a corrugated fiberboard, comprising:
providing a first roll of linerboard having a first width;
providing a second roll of linerboard having a second width less than the first width;
forming a liner having two layers, wherein a first layer is obtained from the first roll of linerboard and a second layer is obtained from the second roll of linerboard, and wherein the first layer and second layer are adhered together;
providing a roll of corrugated medium having a width substantially equal to the first roll of linerboard; and
adhering the liner to the corrugated medium to provide a corrugated fiberboard.

18. The method of claim 17, wherein the second layer is positioned in a substantially central portion of the first layer such that the liner includes a central region having two layers and two edge regions having a single layer.

19. The method of claim 17, wherein the second layer is positioned substantially along an edge portion of the first layer such that the liner includes a first region having two layers and a second region having a single layer.

20. The method of claim 17, wherein the second layer comprises a band positioned near a score or on a flap.

21. A corrugated fiberboard, comprising:
a first region of corrugated fiberboard for providing a first portion of the container that requires a first amount of structural integrity; and
a second region of corrugated fiberboard for providing a second portion of the container that requires a second amount of structural integrity, wherein the second amount of structural integrity is less than the first amount;
wherein both the first region and second region are formed from a fluted medium having a liner adhered to a side of the fluted medium, wherein liner includes:
a first layer that substantially covers both the first region and the second region; and
a second layer adhered to the first layer, wherein the second layer covers the first region and is omitted from covering at least a substantial portion of the second region.

22. The corrugated fiberboard of claim 19, further comprising scores for forming a container.
